(19) United States
(12) Patent Application Publication
(10) Pub. No.: US 2024/0043946 A1
(43) Pub. Date: Feb. 8, 2024

(54) FLUID GUIDE FOR QUENCHING METAL WORKPIECES

(71) Applicant: ALD VACUUM TECHNOLOGIES GMBH, Hanau (DE)

(72) Inventors: Gunther SCHMITT, Hanau (DE); Robin VIEL, Erlensee (DE); Volker HEUER, Frankfurt a.M. (DE)

(73) Assignee: ALD VACUUM TECHNOLOGIES GMBH, Hanau (DE)

(21) Appl. No.: 18/044,009

(22) PCT Filed: Aug. 30, 2021
(86) PCT No.: PCT/EP2021/073910

§ 371 Date: Mar. 3, 2023

(30) Foreign Application Priority Data
Sep. 7, 2020 (DE) 10 2020 123 322.1

(51) Int. Cl. C21D 1/64; C21D 9/00; C21D 9/32

(52) U.S. Cl. CPC C21D 1/64; C21D 9/0025; C21D 9/32

(57) ABSTRACT

In a thermal or thermochemical treatment, metal workpieces together with a metal guide are arranged on a batch carrier. The present invention relates to a device for flow guidance for metallic pieces during such thermal or thermochemical treatment and quenching, as well as methods using the same. The fluid guide particularly ensures a uniform cooling of an inner and/or outer lateral surface of the workpieces during the quenching process.

The present invention relates to a device for flow guidance for metallic pieces during thermal or thermochemical treatment and during quenching, and to a method for thermal or thermochemical treatment and for quenching.

The present invention may also be used for the neutral hardening of high-speed and tool steels.

It is common in the prior art to subject metallic workpieces such as toothed gears to thermochemical treatment. One of the most commonly used methods is case hardening (“Einsatzharten” in German, https://de.wikipedia.org/wiki/Einsatzharten), in which workpieces composed of steel or other alloys are carburized, diffused and quenched in order for a layer with a particular, preferably martensitic structure to be generated on the surface of the workpieces. Further thermochemical methods are carbonitriding, in which carbon and nitrogen are introduced into the workpieces, and nitriding, in which only nitrogen is introduced.

In the case of thermochemical treatment by carburizing and carbonitriding, the workpieces are held at temperatures in the range from 800 to 1100° C. over a period of time from 30 minutes to several hours.

In the case of thermochemical treatment, it is predominantly the case that batches with a quantity or batch size from several tens of workpieces to several hundred workpieces are treated in specially designed systems with one or more lock, furnace and quenching chambers. In exceptional cases, for example in the case of toothed transmission gears and toothed rings with a diameter of greater than 600 mm, or machine parts with stringent precision requirements, the workpieces are treated in series (one-piece flow), with in each case one single workpiece being subjected to one of the thermochemical method steps in one treatment chamber.

Small components with non-critical manufacturing tolerances are commonly treated in the form of bulk-material-like batches with quantities from several hundred to several thousand workpieces. By contrast, relatively large and relatively high-grade components are arranged in ordered fashion on batch carriers in order to ensure controlled process conditions that are as homogeneous as possible. In particular, it is sought to achieve a homogeneous temperature distribution and application of carbon-containing and nitrogen-containing process gases to the workpieces and a uniform flow of quenching or cooling fluid around the workpiece surface.

The batch carriers are generally configured as lattice-like grates, and are composed of a high-temperature-resistant material such as graphite, carbon fiber reinforced carbon (CFRC) or steel with a high nickel content. The production of the batch carriers is laborious and expensive. In order to carry out thermochemical treatment in an economical manner, the batch carriers are used for as long as possible, that is to say for the treatment of numerous batches of workpieces, and are subjected to high mechanical and thermal loads. Mechanical wear occurs when the batch carriers are loaded with workpieces and unloaded. Furthermore, in the case of steels with a high nickel content, the numerous heating and quenching processes cause cumulative thermal distortion. The progressive mechanical and thermal loading has the effect that the surface of the batch carriers exhibits slight unevenness and distortion after just a few production cycles.

Workpieces composed of steel are forgeable, that is to say plastically deformable under the action of force, above a temperature in the range from 500 to 800° C., depending on the steel type. In the context of the present invention, this temperature will be referred to, using the terminology relating to plastics, as “softening temperature” or as “softening point”.

In the case of carburizing and carbonitriding, the workpieces are generally held at a temperature above their “softening point” for a considerable period of time.

A workpiece that has been placed on a batch carrier and heated to above its “softening point” nestles under the action of its own weight against the surface of the batch carrier. If the surface of the batch carrier is sufficiently flat, such that the local curvature is very small or the local radius of curvature is very large in relation to the dimensions of the workpieces, the distortion of the workpieces that results from the heat treatment is minor and falls within specified tolerances. However, if the surface of the batch carrier has one or more unevennesses with a considerable curvature or with a radius of curvature below a critical threshold value, the distortion of the workpieces that results from the heat treatment can exceed the tolerances and give rise to a considerably increased reject rate.

Furthermore, a non-uniform flow of cooling fluid over the workpieces during the quenching process can likewise give rise to distortion of the workpieces.

Various devices and methods for reducing thermal distortion are known in the prior art, such as hydraulic quench presses (cf. https://en.wikipedia.org/wiki/Quench press).

WO 2019/149676 A1 describes a high-temperature-resistant device for providing support and for flow guidance, which device reduces thermal distortion during the thermochemical treatment and quenching of metallic workpieces.

Despite the improvements that have hitherto been achieved, there is still a demand to reduce the thermal distortion of large components, such as toothed rings, which are sensitive to aspects of process engineering.

It is accordingly the object of the present invention to provide a device for further reducing dimensional changes and deformation, or distortion, of metallic workpieces during thermal or thermochemical treatment.

Said object is achieved by a fluid guide for the quenching of metallic workpieces during thermal or thermochemical treatment, comprising a first and a second fluid baffle that are manufactured independently of one another from a material selected from graphite, carbon fiber reinforced carbon (CFRC), oxide ceramic matrix composite (OCMC) or some other ceramic material, wherein the first and the second fluid baffle are configured to delimit a substantially rotationally symmetrical flow channel with a clear width of 5 mm.

Expedient embodiments of the device according to the invention are characterized by the following further features in any combination, provided that the combined features do not contradict one another:
a clear width of the flow channel is 50 mm;
a clear radial width of the flow channel is 5 mm;
a clear radial width of the flow channel is 50 mm;
a part of the surface of the first fluid baffle forms an inner wall of the flow channel;
a part of the surface of the second fluid baffle forms an outer wall of the flow channel;
a radial section through an inner wall of the flow channel has a curvature in certain portions or throughout;
a radial section through an outer wall of the flow channel has a curvature in certain portions or throughout;
a radial section through an inner wall of the flow channel has a continuous profile;
a radial section through an outer wall of the flow channel has a continuous profile;
the flow channel has a first end-side opening or an inlet;
the flow channel has a second end-side opening or an outlet;
a clear radial spacing between an inner and an outer wall of the flow channel decreases in certain portions or throughout in a direction from the inlet to the outlet;
a clear radial spacing between an inner and an outer wall of the flow channel is constant in certain portions in a direction from the inlet to the outlet;
a height of the flow channel in the direction of an axis of rotation is 20 to 200 mm;
a height of the flow channel in the direction of an axis of rotation is 20 to 110 mm or 90 to 200 mm;
a height of the flow channel in the direction of an axis of rotation is 20 to 60 mm, 40 to 80 mm, 60 to 100 mm, 80 to 120 mm, 100 to 140 mm, 120 to 160 mm, 140 to 180 mm, or 160 to 200 mm;
the first and the second fluid baffle are connected to one another by one or more struts;
the first fluid baffle has one or more leadthroughs;
the second fluid baffle has one or more leadthroughs;
the fluid guide comprises an annular or cylindrical pedestal composed of graphite, carbon fiber reinforced carbon, oxide ceramic matrix composite, or some other ceramic material, for the mounting of a workpiece;
the first fluid baffle has a rotationally symmetrical design;
the first fluid baffle is formed as a single piece;
the first fluid baffle is of shell-like configuration;
the first fluid baffle is of shell-like configuration and has a wall thickness of 5 to 30 mm;
the first fluid baffle is configured as a hollow dome;
the first fluid baffle is configured as a hollow dome and has a wall thickness of 5 to 30 mm;
the first fluid baffle is formed in two parts, a first part configured as a solid or hollow cylinder, and a second part configured as a dome-like cover;
the first fluid baffle comprises an outer cylindrical lateral surface;
the first fluid baffle comprises an outer cylindrical lateral surface with a diameter of 80 to 800 mm;
the first fluid baffle comprises an outer cylindrical lateral surface with a diameter of 80 to 500 mm or 200 to 800 mm;
the first fluid baffle comprises an outer cylindrical lateral surface with a diameter of 80 to 200 mm, 100 to 300 mm, 200 to 400 mm, 300 to 500 mm, 400 to 600 mm, 500 to 700 mm or 600 to 800 mm;
the first fluid baffle comprises a first domed end surface;
the first fluid baffle comprises a first end surface configured as a semi-ellipsoid;
the first fluid baffle comprises a first end surface configured as a semi-paraboloid;
the first fluid baffle comprises a first end surface configured as a hemisphere;
the first fluid baffle comprises a second end surface configured as a circular surface;
the first fluid baffle has an annular design;
the first fluid baffle comprises an inner cylindrical lateral surface;
the first fluid baffle comprises an inner cylindrical lateral surface with a diameter of 60 to 760 mm;
the first fluid baffle comprises an inner cylindrical lateral surface with a diameter of 60 to 500 mm or 200 to 760 mm;
the first fluid baffle comprises an inner cylindrical lateral surface with a diameter of 60 to 200 mm, 100 to 300 mm, 200 to 400 mm, 300 to 500 mm, 400 to 600 mm, 500 to 700 mm or 600 to 760 mm;
the first fluid baffle comprises a first end surface configured as a semitorus;
the first fluid baffle comprises a second end surface configured as an annular surface;
the first fluid baffle comprises a second end surface equipped with 3 to 40 support elements;
the second fluid baffle has a rotationally symmetrical design;
the second fluid baffle has an annular design;
the second fluid baffle is formed as a single piece;
the second fluid baffle comprises an outer cylindrical lateral surface;
the second fluid baffle comprises an outer cylindrical lateral surface with a diameter of 100 to 1000 mm;
the second fluid baffle comprises an outer cylindrical lateral surface with a diameter of 100 to 600 mm or 300 to 1000 mm;
the second fluid baffle comprises an outer cylindrical lateral surface with a diameter of 100 to 300 mm, 200 to 400 mm, 300 to 500 mm, 400 to 600 mm, 500 to 700 mm, 600 to 800 mm, 700 to 900 mm or 800 to 1000 mm;
the second fluid baffle comprises an inner cylindrical lateral surface;
the second fluid baffle comprises an inner cylindrical lateral surface with a diameter of 90 to 900 mm;
the second fluid baffle comprises an inner cylindrical lateral surface with a diameter of 90 to 500 mm or 200 to 900 mm;
the second fluid baffle comprises an inner cylindrical lateral surface with a diameter of 90 to 200 mm, 100 to 300 mm, 200 to 400 mm, 300 to 500 mm, 400 to 600 mm, 500 to 700 mm, 600 to 800 mm or 700 to 900 mm;
the second fluid baffle comprises a first end surface configured as a semitorus;
the second fluid baffle comprises a second end surface configured as an annular surface;
the second fluid baffle comprises a second end surface equipped with 3 to 40 support elements;
the pedestal for the mounting of a workpiece comprises an outer cylindrical lateral surface;
the pedestal for the mounting of a workpiece comprises an outer cylindrical lateral surface with a diameter of 100 to 1000 mm;
the pedestal for the mounting of a workpiece comprises an outer cylindrical lateral surface with a diameter of 100 to 600 mm or 300 to 1000 mm;
the pedestal for the mounting of a workpiece comprises an outer cylindrical lateral surface with a diameter of 100 to 300 mm, 200 to 400 mm, 300 to 500 mm, 400 to 600 mm, 500 to 700 mm, 600 to 800 mm, 700 to 900 mm or 800 to 1000 mm;
the pedestal for the mounting of a workpiece comprises an inner cylindrical lateral surface;
the pedestal for the mounting of a workpiece comprises an inner cylindrical lateral surface with a diameter of 60 to 760 mm;
the pedestal for the mounting of a workpiece comprises an inner cylindrical lateral surface with a diameter of 60 to 500 mm or 200 to 760 mm;

the pedestal for the mounting of a workpiece comprises an inner cylindrical lateral surface with a diameter of 60 to 200 mm, 100 to 300 mm, 200 to 400 mm, 300 to 500 mm, 400 to 600 mm, 500 to 700 mm or 600 to 760 mm;
the pedestal for the mounting of a workpiece comprises a first end surface configured as an annular surface;
the pedestal for the mounting of a workpiece comprises a second end surface configured as an annular surface;
the pedestal for the mounting of a workpiece comprises a first and a second end surface, each of which is configured as an annular surface, and a spacing between the first and the second end surface is 10 to 200 mm;
the pedestal for the mounting of a workpiece comprises a first and a second end surface, each of which is configured as an annular surface, and a spacing between the first and the second end surface is 10 to 120 mm or 90 to 200 mm;
the pedestal for the mounting of a workpiece comprises a first and a second end surface, each of which is configured as an annular surface, and a spacing between the first and the second end surface is 10 to 50 mm, 30 to 70 mm, 50 to mm, 70 to 110 mm, 90 to 130 mm, 110 to 150 mm, 130 to 170 mm or 150 to 200 mm;
the fluid guide comprises a third fluid baffle;
the third fluid baffle is manufactured from a material selected from graphite, carbon fiber reinforced carbon (CFRC), oxide ceramic matrix composite (OCMC) or some other ceramic material;

the second and the third fluid baffle are configured to delimit a substantially rotationally symmetrical flow channel with a clear width of 5 mm;

the second and the third fluid baffle are configured to delimit a substantially rotationally symmetrical flow channel with a clear width of 50 mm;

the third fluid baffle has a rotationally symmetrical design;
the third fluid baffle has an annular design;
the third fluid baffle is formed as a single piece;
the third fluid baffle comprises an outer cylindrical lateral surface;
the third fluid baffle comprises an outer cylindrical lateral surface with a diameter of 110 to 1100 mm;
the third fluid baffle comprises an outer cylindrical lateral surface with a diameter of 110 to 700 mm or 400 to 1100 mm;
the third fluid baffle comprises an outer cylindrical lateral surface with a diameter of 110 to 300 mm, 200 to 400 mm, 300 to 500 mm, 400 to 600 mm, 500 to 700 mm, 600 to 800 mm, 700 to 900 mm, 800 to 1000 mm or 900 to 1100 mm;
the third fluid baffle comprises an inner cylindrical lateral surface;
the third fluid baffle comprises an inner cylindrical lateral surface with a diameter of 100 to 1000 mm;
the third fluid baffle comprises an inner cylindrical lateral surface with a diameter of 100 to 500 mm or 300 to 1000 mm;

the third fluid baffle comprises an inner cylindrical lateral surface with a diameter of 100 to 200 mm, 100 to 300 mm, 200 to 400 mm, 300 to 500 mm, 400 to 600 mm, 500 to 700 mm, 600 to 800 mm, 700 to 900 mm or 800 to 1000 mm;
the third fluid baffle comprises a first end surface configured as a semitorus;
the third fluid baffle comprises a second end surface configured as an annular surface;
the third fluid baffle comprises a second end surface equipped with 3 to 40 support elements.

A further object of the invention consists in providing a method for the thermochemical treatment of metallic workpieces with reduced dimensional changes and deformation or reduced distortion.

Said object is achieved by means of a method for thermal or thermochemical treatment and quenching of metallic workpieces, comprising the steps:

arranging 1 to 80 workpieces, in each case together with a fluid guide having the features described above, on a batch carrier;

thermally or thermochemically treating the workpieces;

loading the batch carrier with the workpieces and the fluid guides into a quenching device; and 10 applying a flow of a cooling fluid to the workpieces, the workpieces being cooled from a temperature of 700 to 1220° C. to a temperature of 50 to 300° C., and a flow being applied with a substantially rotationally symmetrical flow profile to each workpiece.

Expedient embodiments of the method according to the invention are characterized by the following further measures in any combination, provided that the combined measures do not contradict one another:
1 to 20 workpieces, 10 to 30 workpieces, 20 to 40 workpieces, 30 to 50 workpieces, 40 to 60 workpieces, 50 to 70 workpieces or 60 to 80 workpieces, each together with a fluid guide, are arranged on a batch carrier;
1 to 3 workpieces, 2 to 4 workpieces, 3 to 5 workpieces, 4 to 6 workpieces, 5 to 7 workpieces, 6 to 8 workpieces, 7 to 9 workpieces or 8 to 10 workpieces, each together with a fluid guide, are arranged on a batch carrier;
1, 2, 3 or 4 workpieces, each together with a fluid guide, are arranged on a batch carrier;
1 workpiece, together with a fluid guide, is arranged on a batch carrier;
the quenching device comprises a flow drive for generating a fluidic main flow, and a first and a second fluid baffle of the fluid guide are arranged between the flow drive and each workpiece in relation to the fluidic main flow, and the first and the second fluid baffle delimit in each case a substantially rotationally symmetrical flow channel;
the quenching device comprises a fluidic recirculation loop with a flow drive, and a fraction of 50 to 100 vol. % of the cooling fluid is recirculated;
the flow profile in a radial direction has a local flow density maximum;
a radius R M of a local flow density maximum of the flow profile and an inner radius Rᵢ of the workpieces satisfy the condition 0.8·Rᵢ≤R_{M}≤1.2·Rᵢ;
a radius R_{M} of a local flow density maximum of the flow profile and an outer radius Rₐ of the workpieces satisfy the condition 0.8·Rₐ≤R_{M}≤1.2·Rₐ;
the flow profile in a radial direction has a first and a second local flow density maximum with an interposed local flow density minimum;
a first radius R_{M2} of a first local flow density maximum of the flow profile and an inner radius Rᵢ of the workpieces satisfy the condition 0.8·Rₐ≤R_{M}≤1.2·Rₐand a second radius R_{M2} of a second local flow density maximum of the flow profile and an outer radius Rₐ of the workpieces satisfy the condition 0.8·Rₐ≤R_{M2}≤1.2·Rₐ;
one or more workpieces are arranged in each case on an annular or cylindrical pedestal;
one or more workpieces are toothed rings with an internal toothing;
one or more workpieces are toothed rings with an internal toothing and the internal toothing projects into the flow channel delimited by the first and second fluid baffles;
one or more workpieces are toothed gears or toothed rings with an external toothing;
one or more workpieces are toothed gears or toothed rings with an external toothing and the external toothing projects into the flow channel delimited by the first and second fluid baffles;
the batch carrier is of lattice-like form;
the batch carrier is manufactured from graphite, carbon fiber reinforced carbon, oxide ceramic matrix composite or some other ceramic material;
the workpieces are quenched with a cooling rate of 1.5 to Kelvin per second (K/s);
the workpieces are quenched with nitrogen (N₂), helium (He), argon (Ar), hydrogen (H₂) or air;
the workpieces are quenched with nitrogen (N₂), helium (He), argon (Ar), hydrogen (H₂) or air, at a gas pressure of 4 to bar.

In the context of the present invention, the expression “rotationally symmetrical” refers to a three-dimensional form or a body which, when rotated through any angle about an axis, is projected onto itself.

In the context of the present invention, the expression “substantially rotationally symmetrical” refers to a three-dimensional shape or a body which, with regard to its total volume, has slight deviations from rotational symmetry in the strict mathematical sense. In particular, the expression “substantially rotationally symmetrical” refers to a fluid guide with a first and a second fluid baffle, which are each rotationally symmetrical and which are connected to one another by 3 to 12 struts, the volume of the connecting struts being less than or equal to 10% in relation to the total volume of the fluid guide 9≤10 vol. %).

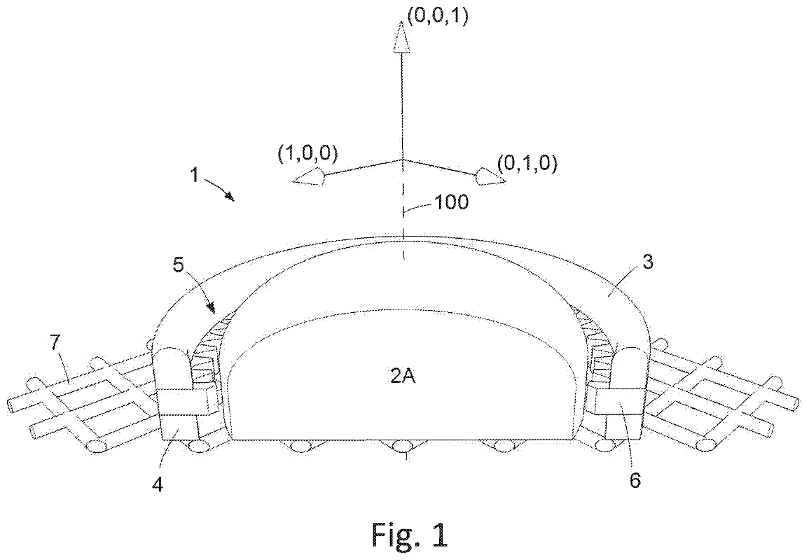

In the context of the invention, the expression “axis of rotation” refers to an axis of symmetry of a three-dimensional shape or of a body which, when rotated through any angle about its respective “axis of rotation”, is projected onto itself (see reference designation 100 in FIGS. 1, 2 and 3).

In the context of the present invention, the expression “radial” refers to a direction pointing perpendicularly outward in relation to an axis of rotation of a rotationally symmetrical shape or of a rotationally symmetrical body. In the illustration of FIGS. 1, 2 and 3, a radial direction is characterized by a vector of the form (cos φ, sin φ, 0), where 0≤φ≤2 π.

In the context of the present invention, the expressions “continuous” or “continuous profile” refer to boundaries, contours and surfaces of physical bodies, for example of a fluid baffle or of a flow channel, which can be approximated, with a standard deviation (at least squares) of ≤100 μm, by mathematically continuous curves or surfaces.

In the context of the present invention, the expression “flow channel” refers to a spatial region which is delimited by a surface of the first or inner fluid baffle and a surface of the second or outer fluid baffle, the first and second fluid baffle being arranged coaxially with respect to one another in terms of their axes of rotation, with surface normal vectors \vec{s} of the first fluid baffle having a positive radial component and surface normal vectors \vec{t} of the second fluid baffle having a negative radial component. The above conditions for surfaces or surface regions that delimit the flow channel are described mathematically by the following relationships.

First fluid baffle:

$$\vec{s} - [ \vec{s} \cdot ( \begin{matrix}0 \\ 0 \\ 1\end{matrix} ) ] ( \begin{matrix}0 \\ 0 \\ 1\end{matrix} ) = σ ( \begin{matrix}cos χ \\ sin χ \\ 0\end{matrix} )$$

where σ≥0 and 0≤X≤2 π;

Second fluid baffle:

$$\vec{t} - [ \vec{t} \cdot ( \begin{matrix}0 \\ 0 \\ 1\end{matrix} ) ] ( \begin{matrix}0 \\ 0 \\ 1\end{matrix} ) = τ ( \begin{matrix}cos ψ \\ sin ψ \\ 0\end{matrix} )$$

where τ≤0 and 0≤ψ≤2 π.

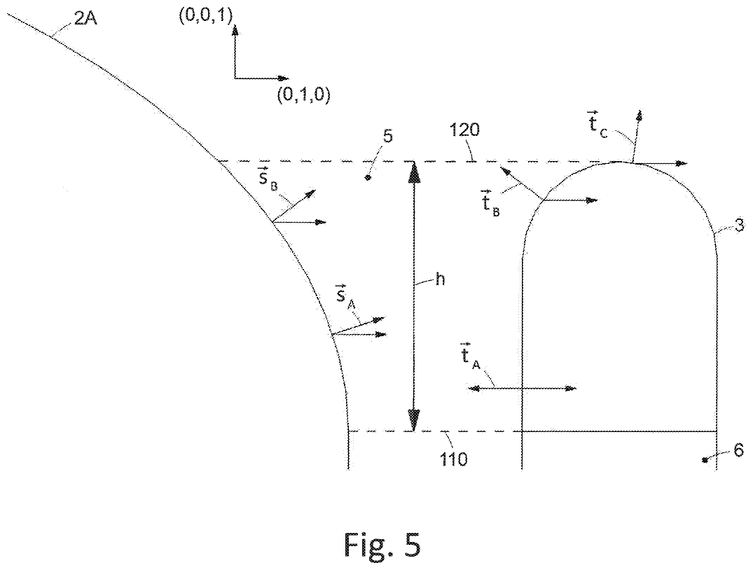

FIG. 5 illustrates the above conditions in graphical form.

The inventors have surprisingly found that an annular fluid guide makes it possible, when quenching metallic workpieces with a cooling fluid, to reduce thermal distortions to a level considerably below the values that are achievable with known methods and devices. Initial simulations carried out using computational fluid dynamics (CFD) software indicate that the fluid guide according to the invention makes the flow guidance at the surface of the workpiece much more uniform, and in particular suppresses the formation of recirculation regions at the surface of the workpiece. This advantageous effect can be intensified by a shape of the surface of the fluid guide according to the invention that is characterized by a substantially rotationally symmetrical and funnel-like narrowing flow channel. It has furthermore proven expedient for the surface of the fluid guide to have a continuous contour with moderate local curvature.

The invention will be discussed in more detail below on the basis of figures and examples. In the figures:

FIG. 1 shows a perspective sectional view of a fluid guide for a toothed ring with internal toothing;

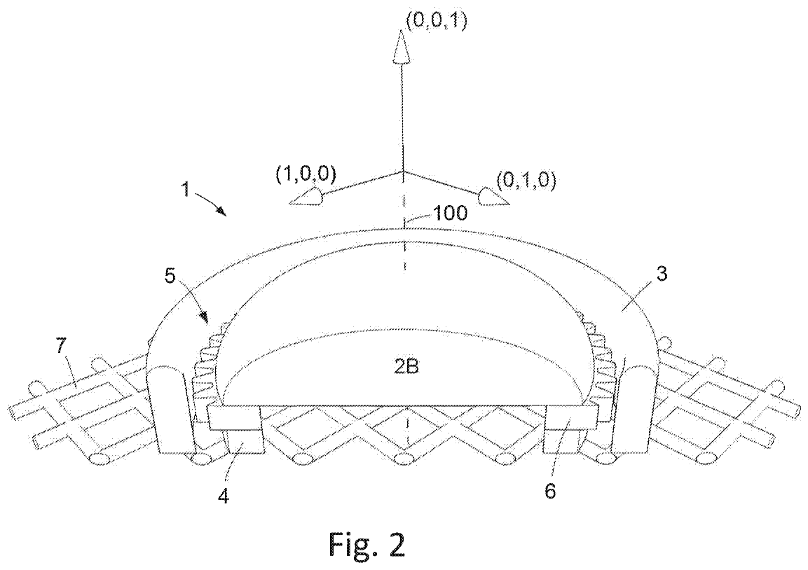

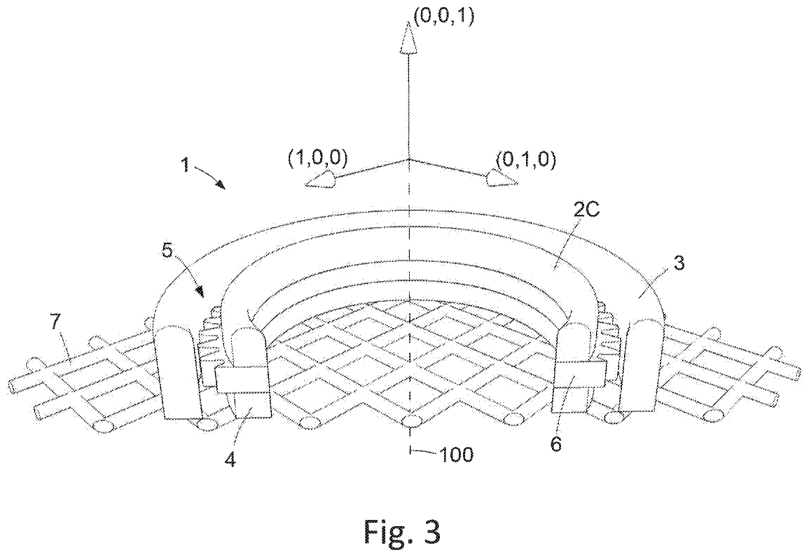

FIGS. 2-3 show perspective sectional views of fluid guides for toothed rings or toothed gears with internal or external toothing;

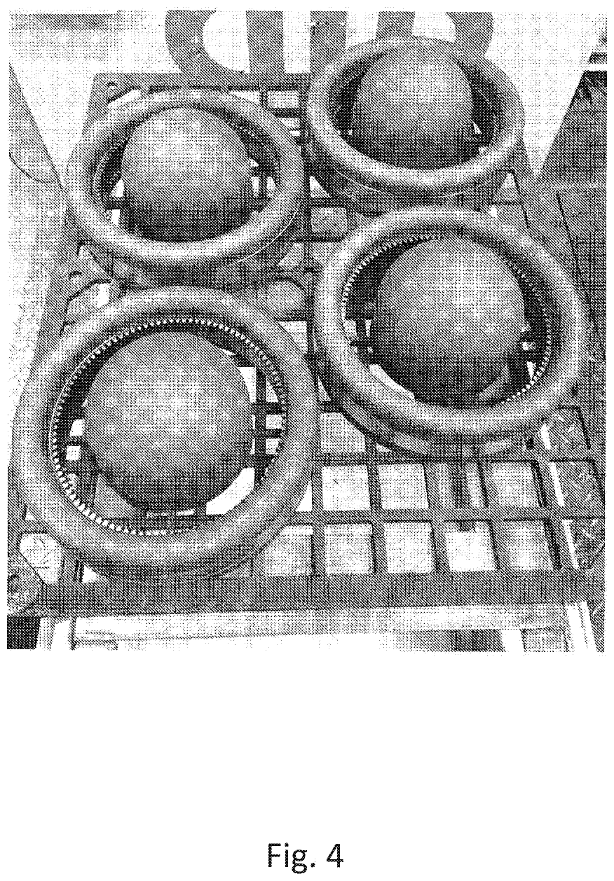

FIG. 4 shows a batch carrier with four toothed rings, each with a fluid guide;

FIG. 5 shows a sectional view of a flow channel delimited by a fluid guide;

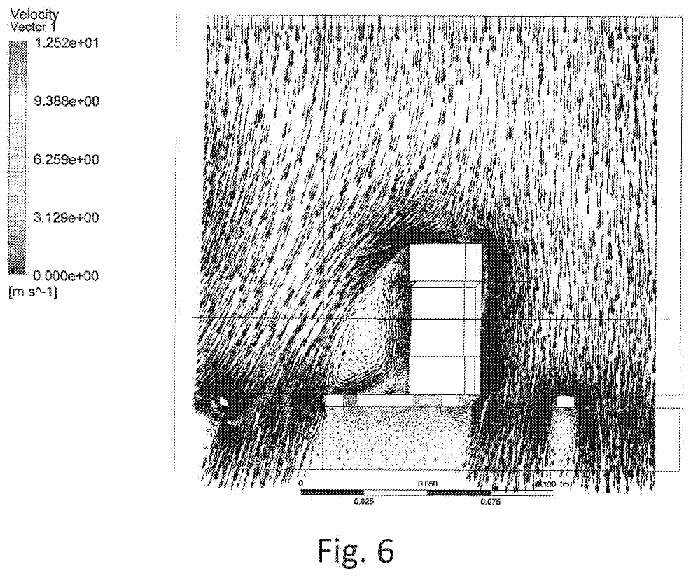

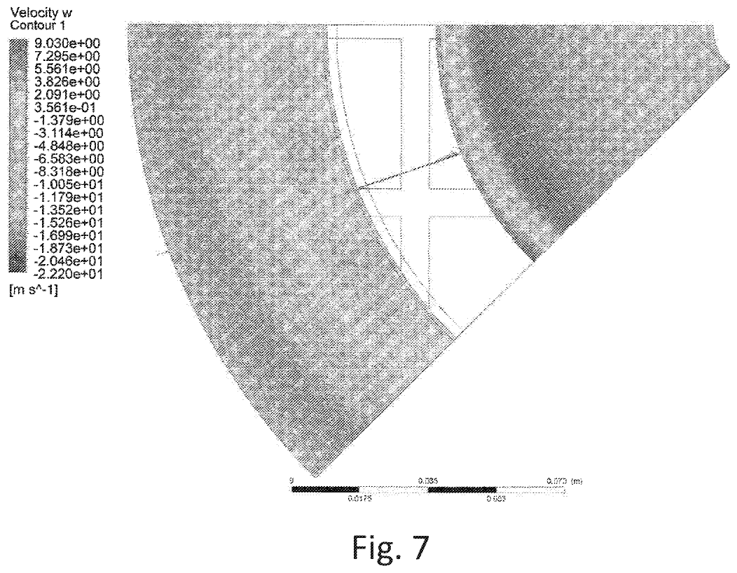

FIGS. 6 and 7 show CFD flow profiles of known fluid guides; and

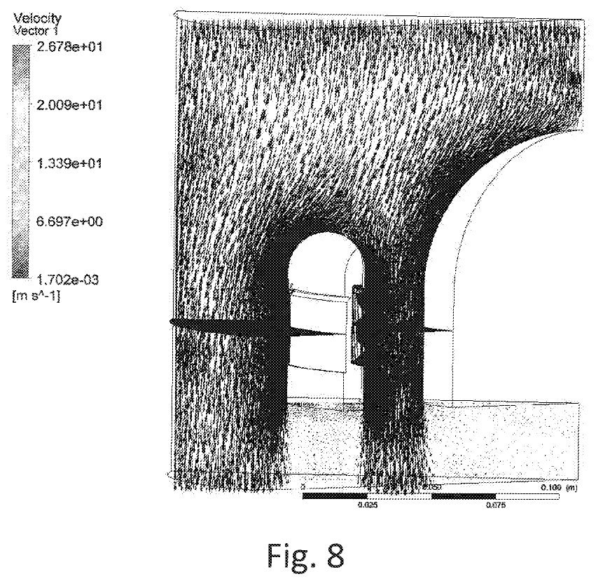

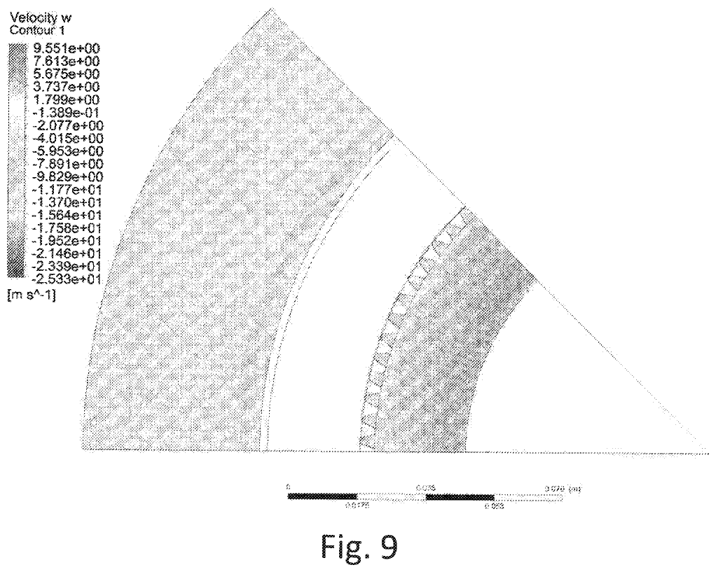

FIGS. 8 and 9 show CFD flow profiles of a fluid guide according to the invention.

FIG. 1 shows a perspective sectional view of a workpiece or toothed ring 6 with an internal toothing, which is arranged together with a fluid guide 1 according to the invention on a lattice-like batch carrier 7. The fluid guide 1 comprises a first or inner fluid baffle 2A, a second or outer fluid baffle 3, and an annular pedestal 4, on which the toothed ring 6 is mounted. The first and the second fluid baffle (2A, 3) are configured and arranged relative to one another such that they delimit a substantially rotationally symmetrical flow channel with a clear width of 5 mm, and the internal toothing of the toothed ring 6 projects into the flow channel 5. In a further expedient embodiment of the invention, by contrast to the illustration of FIG. 1, the first fluid baffle is configured as a hollow dome. FIG. 1 furthermore shows three axes (1,0,0), (0,1,0) and (0,0,1) of a Cartesian coordinate system, and an axis of rotation 100 of the fluid guide 1, which axis of rotation is coaxial with respect to the axis (0,0,1). In accordance with normal convention, the axis (0,0,1) represents the vertical direction.

The illustration of FIG. 1 corresponds to the test arrangement shown in FIG. 4, in which four toothed rings, each together with a fluid guide comprising two fluid baffles and one support, are arranged on a lattice-like batch carrier.

FIG. 2 shows a perspective sectional view of a workpiece or toothed ring 6 with an external toothing, which is arranged together with a fluid guide 1 according to the invention on a lattice-like batch carrier 7. The fluid guide 1 comprises a first or inner fluid baffle 2B, a second or outer fluid baffle 3, and an annular pedestal 4, on which the toothed ring 6 is mounted. The first and the second fluid baffle (2A, 3) are configured and arranged relative to one another such that they delimit a substantially rotationally symmetrical flow channel 5 with a clear width of ≥5 mm, and the external toothing of the toothed ring 6 projects into the flow channel 5. In a further expedient embodiment of the invention, by contrast to the illustration of FIG. 2, the first fluid baffle is configured as a hollow dome. FIG. 2 furthermore shows three axes (1,0,0), (0,1,0) and (0,0,1) of a Cartesian coordinate system, and an axis of rotation 100 of the fluid guide 1, which axis of rotation is coaxial with respect to the axis (0,0,1).

In accordance with normal convention, the axis (0,0,1) represents the vertical direction.

FIG. 3 shows a further embodiment of the fluid guide 1 according to the invention with an annular first or inner fluid baffle 2C. The other reference designations in FIG. 3 have the same meaning as discussed above in conjunction with FIG. 2.

In an expedient embodiment that is not shown in FIGS. 1-3, the fluid guide according to the invention comprises a third fluid baffle. The third fluid baffle is configured such that, when arranged centrally relative to the second fluid baffle, said third fluid baffle delimits a second, outer, substantially rotationally symmetrical flow channel. Said outer flow channel causes a uniform and preferably accelerated flow of cooling fluid over an outer surface of the workpiece. Uniform heat transfer at the outer surface of the workpiece is thus achieved.

According to the invention, one or more workpieces 6, each together with a fluid guide 1, is or are arranged on the batch carrier 7, thermally or thermochemically treated, and subsequently quenched. The quenching is preferably performed with a cooling gas that is composed primarily of nitrogen (N₂) or of helium (He). Argon (Ar), hydrogen (H₂) and air may likewise be used as cooling gas. During the quenching, the cooling gas is accelerated by means of a flow drive configured as a high-pressure fan, and a flow is applied to the workpieces 6 and fluid guides 1 substantially vertically downward from above, or in the direction (0,0, −1). For this purpose, the flow drive may be arranged, relative to the charge carrier, above or below or in a correspondingly configured fluidic recirculation loop.

FIG. 5 shows a schematic view of a partial frontal section of a fluid guide of the type illustrated in FIG. 1, with first and second fluid baffles 2A and 3 and a workpiece 6. The frontal section plane is spanned by the coordinate axes or base vectors (0,1,0) and (0,0,1). The axis of rotation of the fluid guide and of the first and second fluid baffles 2A and 3 runs coaxially with respect to the axis (0,0,1). A flow channel 5 is delimited by surfaces or surface regions of the first and second fluid baffles 2A and 3, in which radial components of respective surface normal vectors \vec{s}_{A}, \vec{s}_{B} and \vec{t}_{A}, \vec{t}_{B} are positive and negative respectively. For comparison, a further surface normal vector \vec{t}_{C} for the second fluid baffle 3 is shown, which has a positive radial component and the associated surface region of which, in the context of the invention, is not assigned to the flow channel 5 and is situated “outside” the flow channel 5. In the frontal sectional view of FIG. 5, the vector (0,0,1) represents the radial direction in each case, and, in order to provide a simplified view, is illustrated for each surface normal vector \vec{s}_{A}, \vec{s}_{B} and \vec{t}_{A}, \vec{t}_{B}, \vec{t}_{C}. In the frontal section plane of FIG. 5, the flow channel 5 is defined by the following mathematical relationships:

$${\vec{s}}_{i} \cdot ( \begin{matrix}0 \\ 1 \\ 0\end{matrix} ) \geq 0 , i = A , B , … ; {\vec{t}}_{j} \cdot ( \begin{matrix}0 \\ 1 \\ 0\end{matrix} ) \leq 0 , j = A , B , …$$

Accordingly, the flow channel 5 is delimited in the direction of the coordinate axis (0,0,1) by the two dashed lines 110 and 120, the spacing h or (0,0,h) of which indicates the height of the flow channel 5.

FIGS. 6 and 7 show a radial sectional view and a plan view of the flow velocity field during quenching with nitrogen using a fluid guide known from WO 2019/149676 A1. The flow velocity field of FIGS. 6 and 7 was calculated using computational fluid dynamics (CFD) software, with realistic boundary conditions being specified. Both FIG. 6 and FIG. 7 show highly pronounced inhomogeneities in the flow, which are evidently attributable to flow separation and a pronounced recirculation region. The flow inhomogeneities cause intense fluctuations in the heat transfer between the workpiece and quenching gas and, in conjunction with this, spatially non-uniform cooling with corresponding thermal distortion.

FIGS. 8 and 9 show a radial sectional view and a plan view of the flow velocity field during quenching with nitrogen using a fluid guide according to the invention. The specifications or boundary conditions for the calculation of the flow velocity field of FIGS. 8 and 9 are identical to those of FIGS. 6 and 7. It is readily apparent from FIGS. 8 and 9 that the flow field exhibits no flow separation at the inner and outer lateral surfaces of the workpiece, and in particular, the formation of a circulation region is suppressed. The flow guidance at the surface of the workpiece is greatly homogenized. Furthermore, the local flow velocity and thus the heat transfer are increased. Even steels of relatively poor alloy content can thus be successfully treated.

### Comparative Example

Four toothed rings composed of steel and with an internal toothing (outer diameter 450 mm, inner diameter 350 mm, height 40 mm) were provided. On each of the toothed rings, the roundness, that is to say the circular radial run-out tolerance of the internal toothing, was measured in accordance with DIN EN ISO 12181-1:2011-07. The measurements were performed on a Gleason 300 GMS P toothed-gear inspection system.

After the measurement, the four toothed rings were arranged, each with a known fluid guide, adjacent to one another on a lattice-like batch carrier and, in a SyncroTherm® system from the company ALD, carburized at 950° C. at a low pressure of approximately 15 mbar and subsequently quenched using compressed nitrogen. The duration of the thermochemical treatment, with the method steps of heating, carburizing, diffusion and quenching, was 2 hours. The cooling rate during the quenching corresponded to approximately 7.7 Kelvin per second(K/s). The fluid guide known from WO 2019/149676 A1 comprises a support and a cover which are each configured as cylindrical rings with an outer and an inner diameter of 450 mm and 370 mm respectively and a height of 50 mm. Aside from a dome-shaped inner flow baffle and a rounded contour of the cover, the known fluid guide is of similar design to the fluid guide according to the invention shown in FIG. 4.

After the thermochemical treatment, the roundness of the toothed rings was measured again, and the minimum, average and maximum distortion were calculated for each toothed ring on the basis of the ratio of the roundness values before and after the thermochemical treatment.

Here, the following values were obtained for the roundness distortion:

Minimum distortion: 6%

Average distortion: 100%

Maximum distortion: 200%

### Example

Analogously to the comparative example above, six toothed rings of the same type were measured and were each, together with a fluid guide according to the invention, carburized, quenched and subsequently measured again. The first batch with four toothed rings and four fluid guides according to the invention is shown in FIG. 4.

The following values were obtained for the roundness distortion:

Minimum distortion: 10%

Average distortion: 44%

Maximum distortion: 89%

It is apparent from the examples that the roundness distortion can be considerably reduced with the aid of the fluid guide according to the invention.

### LIST OF REFERENCE DESIGNATIONS

1 Fluid guide

2A First/inner fluid baffle (first embodiment)

2B First/inner fluid baffle (second embodiment)

2C First/inner fluid baffle (third embodiment)

3 Second/outer fluid baffle

4 Pedestal (support)

5 Flow channel

6 Workpiece

7 Batch carrier

100 Axis of rotation

110 Lower boundary of the flow channel

120 Upper boundary of the flow channel

\vec{s}_{A} Surface normal vector of the first/inner fluid baffle

\vec{s}_{B} Surface normal vector of the first/inner fluid baffle

\vec{t}_{A} Surface normal vector of the second/outer fluid baffle

\vec{t}_{B} Surface normal vector of the second/outer fluid baffle

\vec{t}_{C} Surface normal vector of the second/outer fluid baffle

h Height of the flow channel

1. A fluid guide for the quenching of metallic workpieces during thermal or thermochemical treatment, comprising a first and a second fluid baffle that are manufactured independently of one another from a material selected from graphite, carbon fiber reinforced carbon (CFRC), oxide ceramic matrix composite (OCMC) or some other ceramic material;
wherein the first and the second fluid baffle are configured to delimit a substantially rotationally symmetrical flow channel with a clear width of ≥5 mm.

2. The fluid guide as claimed in claim 1, wherein a clear width of the flow channel is ≤50 mm.

3. The fluid guide as claimed in claim 1, wherein the first and the second fluid baffle are connected to one another by one or more struts.

4. The fluid guide as claimed in claim 1, wherein the first and/or the second fluid baffle have, independently of one another, one or more leadthroughs.

5. The fluid guide as claimed in claim 1, wherein the first and/or the second fluid baffle are equipped, independently of one another, with 3 to 40 support elements.

6. The fluid guide as claimed in claim 1, wherein said fluid guide comprises an annular or cylindrical pedestal (4) comprised of graphite, carbon fiber reinforced carbon (CFRC), oxide ceramic matrix composite (OCMC), or other ceramic material, for the mounting of a workpiece.

7. The fluid guide as claimed in claim 1, wherein said fluid guide comprises a third fluid baffle.

8. The fluid guide as claimed in claim 7, wherein the second fluid baffle and the third fluid baffle are configured to delimit a substantially rotationally symmetrical flow channel with a clear width of ≥5 mm and ≤50 mm.

9. A method for thermal or thermochemical treatment and quenching of metallic workpieces, comprising the steps:
arranging 1 to 80 workpieces, in each case together with a fluid guide as claimed in claim 1, on a batch carrier;
thermally or thermochemically treating the workpieces;
loading the batch carrier with the workpieces and the fluid guides into a quenching device; and
applying a flow of a cooling fluid to the workpieces, the workpieces being cooled from a temperature of 700 to 1220° C. to a temperature of 50 to 300° C.;
wherein a flow is applied with a substantially rotationally symmetrical flow profile to each workpiece.

10. The method as claimed in claim 9, wherein the quenching device comprises a flow drive for generating a fluidic main flow, and a first and a second fluid baffle of the fluid guide are arranged between the flow drive and each workpiece in relation to the fluidic main flow, and the first and the second fluid baffle delimit in each case a substantially rotationally symmetrical flow channel.

11. The method as claimed in claim 9, wherein the flow profile in a radial direction has a local flow density maximum.

12. The method as claimed in claim 11, wherein a radius R_{M} of a local flow density maximum of the flow profile and an inner radius R, of the workpieces satisfy the condition 0.8·Rᵢ≤R_{M}≤1.2·Rᵢ.

13. The method as claimed in claim 11 wherein a radius R_{M} of a local flow density maximum of the flow profile and an outer radius Ra of the workpieces satisfy the condition 0.8·Rₐ≤R_{M}≤1.2·Rₐ.

14. The method as claimed in claim 10, wherein a third fluid baffle of the fluid guide is arranged between the flow drive and each workpiece in relation to the fluidic main flow, and the second fluid baffle and the third fluid baffle delimit in each case a substantially rotationally symmetrical flow channel.

15. The method as claimed in claim 9, wherein one or more workpieces are arranged in each case on a ring-shaped or cylindrical pedestal.
